(19) United States
(12) Patent Application Publication
(10) Pub. No.: US 2026/0316987 A1
(43) Pub. Date: Oct. 15, 2026

(54) LABEL APPLICATOR

(71) Applicant: Domino UK Limited, Cambridge (GB)

(72) Inventors: Lars Jerry Karlsson, Malmö (SE); Carl-Magnus Siwe Larsson, Malmö (SE)

(21) Appl. No.: 19/480,867

(22) PCT Filed: May 3, 2024
(86) PCT No.: PCT/GB2024/051182

§ 371 Date: Nov. 3, 2025

(30) Foreign Application Priority Data
May 4, 2023 (GB) 2306629.3

(51) Int. Cl. B65C 9/36; B41J 3/407; B65C 9/28; B65C 9/40; G01D 5/14

(52) U.S. Cl. CPC B65C 9/36; B65C 9/28; B65C 9/40; G01D 5/145; B41J 3/4075

(57) ABSTRACT

A label applicator (10) has a mounting part (12), a label application part (14), a joint (16) connecting the mounting part (12) and the label application part (14), the joint (16) allowing the label application part (14) to deflect relative to the mounting part (12), biasing means (16) that bias the label application part (14) into a rest position relative to the mounting part (12), and an actuator (18) coupled to the mounting part (12) to move the label application part (14) into contact with an object to be labelled, wherein the joint (16) allows translation of the label application part (14) from the rest position towards the mounting part (12). Also a flexible elastic member (16) for use in such a label applicator, and a print and apply labelling machine (80) that includes such a label applicator.

### FIELD OF THE INVENTION

This invention relates to a label applicator, to a flexible elastic member for use in such a label applicator, and to a print and apply labelling machine (PALM) that includes such a label applicator.

### BACKGROUND TO THE INVENTION

A PALM has a label printer operable to print a self-adhesive label and a label applicator operable to receive a printed label from the label printer and to apply the printed label to an object to be labelled. The label applicator has a label application part for receiving a printed side of the printed label, and an actuator operable either to position the label application part against the object to be labelled to press a self-adhesive side of the printed label against the object to be labelled, or to position the label application part adjacent to the object to be labelled and to transfer the printed label from the label application part to the object to be labelled using one or more jets of air applied to the printed side of the printed label. U.S. Pat. No. 4,844,771 shows such a PALM.

Where the actuator is operable to position the label application part against the object to be labelled, the actuator must be capable of pressing the entire self-adhesive side of the printed label against the object to be printed without damaging the object to be labelled.

U.S. Pat. No. 11,370,574 is concerned with a label applicator comprising a mounting part, a label application part, and a joint connecting the mounting and label application parts and configured to allow the label application part to deflect relative to the mounting part. The joint is of relatively complex construction. The label applicator of U.S. Pat. No. 11,370,574 also employs a relatively complex control system, which adjusts its control parameters in response to detecting a collision between the label application part and an object to be labelled.

### SUMMARY OF THE INVENTION

According to a first aspect of the invention there is provided a label applicator comprising a mounting part, a label application part, a joint connecting the mounting part and the label application part, the joint being configured to allow the label application part to deflect relative to the mounting part, biasing means configured and operable to bias the label application part into a rest position relative to the mounting part, and an actuator coupled to the mounting part, the actuator being configured and operable to move the label application part into contact with an object to be labelled, wherein the joint is further configured and operable to allow translation of the label application part from the rest position towards the mounting part.

The invention can provide a label applicator that is of simple construction and can reduce the risk of damaging an object to be labelled without the use of a complex control system.

Preferably the joint includes a flexible elastic member and the biasing means comprise the flexible elastic member.

The flexible elastic member preferably comprises a single component located between the mounting part and the label application part.

In a preferred embodiment the flexible elastic member comprises a pad having opposed, substantially parallel surfaces, one surface for engagement with the mounting part and the other surface for engagement with the label application part.

Preferably the pad is a foam pad.

The joint may advantageously be configured to allow the label application part to deflect relative to the mounting part through angles up to approximately 15°.

Preferably the joint is configured to allow the label application part to deflect relative to the mounting part through angles up to approximately 10°.

In a preferred embodiment the flexible elastic member forms a universal joint between the mounting part and the label application part.

Preferably the label application part includes a substantially planar contact surface.

Preferably the label applicator further comprises a vacuum and/or pressure connection between the mounting part and the label application part.

In a preferred embodiment the vacuum and/or pressure connection passes through the joint.

The label applicator may advantageously further comprise a magnet coupled to one of the label application part and the mounting part, and a magnetic sensor coupled to the other of the label application part and the mounting part, the magnet and the magnetic sensor being configured and operable to sense a position of the label application part relative to the mounting part.

In a preferred embodiment the magnet is coupled to the label application part and the magnetic sensor is coupled to the mounting part.

Preferably the magnetic sensor comprises a Hall effect sensor.

In a preferred embodiment the magnetic sensor is attached to the mounting part and the magnet is attached to the label application part.

Preferably the label application part is formed with a projection that projects towards the mounting part, the magnet is attached to the projection and the flexible elastic member is provided with an opening to accommodate the projection.

In this way sensitivity of the magnetic sensor to movement of the magnet can be increased.

Preferably the label application part and the mounting part are held in contact with the flexible elastic member by retaining pins extending through the flexible elastic member, the pins being configured and mounted to allow the flexible elastic member to compress and deflect.

According to a second aspect of the invention there is provided a flexible elastic member for use in a label applicator in accordance with the first aspect of the invention.

In a preferred embodiment the flexible elastic member comprises a pad having opposed, substantially parallel surfaces, one surface being configured for engagement with the mounting part and the other surface being configured for engagement with the label application part.

Preferably the flexible elastic member is formed with at least one channel for a flow of fluid through the flexible elastic member.

The flexible elastic member enables a mounting part to be coupled to a label application part of a label applicator such that the label application part can be translated, as well as articulated, relative to the mounting part.

The flexible elastic member further enables a flow of fluid between the label application part and the mounting part without the use of additional tubes or pipes.

Preferably the flexible elastic member is formed from sponge foam.

Preferably the sponge foam comprises a silicone rubber.

Preferably the sponge foam is a closed cell foam.

Preferably the sponge foam has a density of 300 kg/m³+/−100 kg/m³.

Preferably at least some surface parts of the flexible elastic member are substantially air-impervious.

Preferably the at least some surface parts are moulded with, or coated with, a substantially air-impervious surface finish.

In a preferred embodiment the flexible elastic member is formed with at least one channel for coupling a label application part to a vacuum source, and at least one channel for coupling the label application part to a source of pressurised air.

In a preferred embodiment the flexible elastic member is formed with a first channel for coupling a label application part to a vacuum source, and second and third channels for coupling a label application part to a source of pressurised air.

The flexible elastic member may advantageously be formed with an opening for receiving a magnet.

The flexible elastic member may advantageously be formed with at least one channel for a fastening element that couples a label application part to a mounting part.

Preferably the flexible elastic member is formed with a plurality of channels for fastening elements that couple a label application part to a mounting part.

The plurality of channels for fastening elements can substantially prevent movement of the flexible elastic member relative to a label application part and to a mounting part in use of the flexible elastic member.

In a preferred embodiment, the flexible elastic member is generally disc-shaped, with a plurality of radially projecting lobes regularly distributed around a circumference of the flexible elastic member, the plurality of channels for fastening elements being formed in the plurality of radially projecting lobes.

In a preferred embodiment the flexible elastic member is generally disc-shaped and the opening for receiving a magnet is formed at a centre of the flexible elastic member.

According to a third aspect of the invention there is provided a label applicator comprising a mounting part, a label application part, a joint connecting the mounting part and the label application part, the joint being configured to allow the label application part to deflect relative to the mounting part, and an actuator coupled to the mounting part, the actuator being configured and operable to move the label application part into contact with an object to be labelled, wherein the label applicator further includes a magnet and a magnetic sensor, the magnet and the magnetic sensor being mounted, configured and operable to sense a position of the label application part relative to the mounting part.

The label applicator may advantageously further comprise biasing means configured and operable to bias the label application part into a rest position relative to the mounting part.

Where the label applicator further comprises the biasing means, the magnet and the magnetic sensor can be used to determine when the label application part has come into contact with an object to be labelled, because the label application part is likely to be deflected relative to the mounting part from the rest position.

Preferably the magnet is coupled to one of the mounting part and the label application part and the magnetic sensor is coupled to the other of the mounting part and the label application part.

Preferably the magnet is attached to the label application part and the magnetic sensor is attached to the mounting part.

This arrangement of the magnet and magnetic sensor avoids the need to make an electrical connection for the magnetic sensor to the label application part, which is required to be movable relative to the other parts of the label applicator.

Preferably the magnetic sensor comprises a Hall effect sensor.

According to a fourth aspect of the invention there is provided a print and apply labelling machine that includes a label applicator according to the first or third aspect of the invention.

Any component or part mentioned above may be combined with any other component to form an embodiment of the invention as defined in any independent claim. The scope of the invention as claimed need not be restricted to a particular combination of components described in the embodiment that follows.

### BRIEF DESCRIPTION OF THE DRAWINGS

The invention will now be described, by way of example, with reference to the attached drawing figures, in which:

FIG. 1 is a partial cross-section through a label applicator in accordance with the invention;

FIG. 2 is an isometric view of a flexible elastic member of the label applicator of FIG. 1; and

FIG. 3 is an isometric view of a print and apply labelling machine (PALM) including the label applicator of FIG. 2.

### DETAILED DESCRIPTION OF AN EMBODIMENT

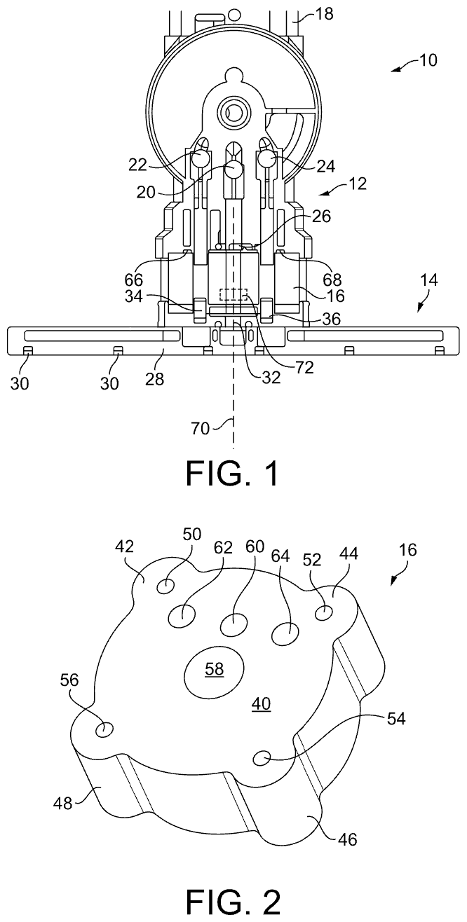

The label applicator 10 of FIG. 1 comprises a mounting part 12, a label application part 14, a joint in the form of a foam pad 16 and an actuator in the form of a robot arm 18, of which a distal portion that is coupled to the mounting part 12 is shown in FIG. 1.

The mounting part 12 is formed with a vacuum tube 20 for connection to a vacuum source (not shown), and first and second compressed air tubes, 22 and 24, respectively, for connection to a source of compressed air (not shown). Attached to the mounting part 12 is a printed circuit board 26 that includes a 3D Hall effect sensor and a pressure sensor.

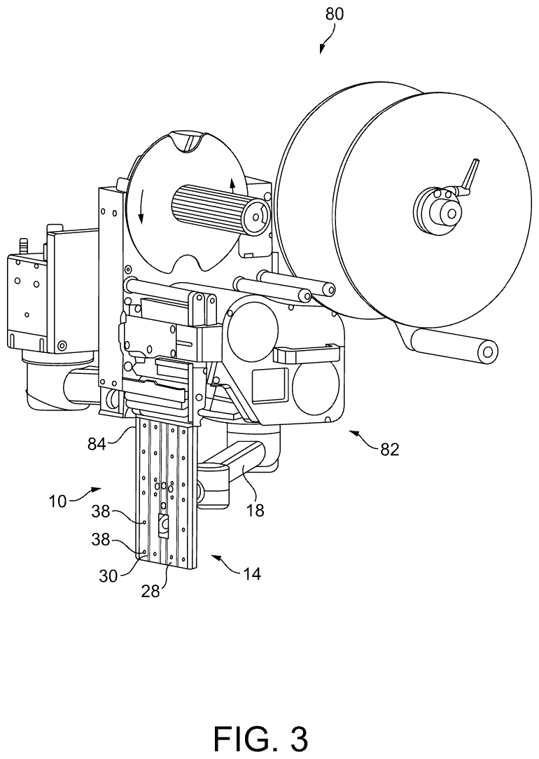

The label application part 14 has a generally flat label receiving surface 28 provided with parallel slots 30. A side of the label application part 14 opposite to the label receiving surface 28 is formed with a vacuum tube 32 and first and second compressed air tubes, 34 and 36, respectively. The label application part 14 is formed with internal channels (not shown) that connect the vacuum tube 32 to the parallel slots 30. The label application part 14 is also formed with internal channels (not shown) that connect the first and second compressed air tubes 34 and 36 to air nozzles (not shown in FIG. 1 but shown in FIG. 3, denoted by reference numeral 38).

Turning to FIG. 2, the foam pad 16 has a generally disc-shaped body 40 with four radially projecting lobes 42, 44, 46 and 48 regularly distributed around the circumference of the disc-shaped body 40. Each lobe 42, 44, 46 and 48 is formed with a respective channel 50, 52, 54 and 56 for a fastening pin (not shown). The disc-shaped body 40 is formed with a central opening 58 for receiving a magnet (not shown). The disc-shaped body 40 is also formed with a vacuum channel 60 and first and second compressed air channels, 62 and 64, respectively. The channels 50, 52, 54, 56, 60, 62 and 64 and opening 58 pass through the foam pad 16 from one axial face of the body 40 to the opposite axial face.

The foam pad 16 is water jet cut from a 20 mm thick sheet of closed cell silicone VMQ sheet with a density of 300 kg/m³+/−100 kg/m³.

Returning to FIG. 1, the foam pad 16 connects the mounting part 12 and the label application part 14. An end portion of the vacuum tube 20 of the mounting part 12 projects into, and forms an interference fit in, one end of the vacuum channel 60 of the foam pad 16 and an end portion of the vacuum channel 32 of the label application part 14 projects into, and forms an interference fit in, the other end of the vacuum channel 60 of the foam pad 16, such that the parallel slots 30 of the label application part 14 are connected to the vacuum source.

Similarly, end portions of the first and second compressed air tubes 22 and 24 of the mounting part 12 and end portions of the first and second compressed air tubes 34 and 36 of the label application part 14 project into, and form interference fits in, opposite ends of the first and second compressed air channels 62 and 64 of the foam pad 16, such that the air nozzles 38 are connected to the source of compressed air.

In use of the label applicator 10 suction generated by the connection of the parallel slots 30 to the vacuum source causes a printed side of a printed label to be retained against the label receiving surface 28 until a self-adhesive side of the printed label is pressed against an object to be labelled, such as a package on a production line.

The air nozzles 38 are for a mode of use of the label applicator 10 in which the robot arm 18 positions the label receiving surface 28 adjacent to an object to be labelled, with a printed side of a printed label retained against the label receiving surface 28 and a self-adhesive side of the printed label facing the object to be labelled, and jets of air discharged through the nozzles 38 detach the printed label from the label receiving surface 28 and press the self-adhesive side of the printed label against the object to be labelled to adhere the printed label to the object to be labelled.

It will be apparent that, under normal circumstances, the invention is of less benefit in the latter mode of use of the label applicator 10 because the label application part 14 does not come into contact with the object to be labelled, so translational movement of the label application part 14 relative to the mounting part 12 is not required. However, the invention may be beneficial if an object to be labelled is incorrectly placed on a production line, because if the label application part 14 collides with an incorrectly placed object to be labelled, translational movement of the label application part 14 relative to the mounting part 12 can occur, reducing the likelihood of damage by the label application part 14 to the object to be labelled.

The foam pad 16 is held under slight compression between the label application part 14 and the mounting part 12 by the heads of four fastening pins, which are located in, but float in both axial and radial directions relative to, sockets formed in the label application part 14 and the mounting part 12. The shanks of the four fastening pins pass through the channels 50, 52, 54 and 56 in the foam pad 16. The heads of two of the pins, denoted by reference numerals 66 and 68, are shown in FIG. 1.

An axis 70 can be imagined as passing through the centre of the central opening 58 of the foam pad 16, perpendicular to the axial faces of the body 40 of the foam pad 16.

The foam pad 16 acts against the four fastening pins to bias the label application part 14 into a rest position in which the axis 70 is perpendicular to the label receiving surface 28 of the label application part 14 and parallel to the end portions of the vacuum tube 20 and first and second compressed air tubes 22 and 24 of the mounting part 12.

The four fastening pins prevent rotation of the label application part 14 relative to the mounting part 12 about the axis 70.

Deflection of the label application part 14 relative to the mounting part 12, such that a line perpendicular to the label receiving surface 28 forms an acute angle with the axis 70, is possible for angles up to 10°. That is to say, the four fastening pins and the foam pad 16 form a universal joint between the label application part 14 and the mounting part 12.

Translation of the label application part 14 from the rest position towards the mounting part 12 along the axis 70 is possible over a distance of approximately 15 mm.

The label application part 14 is provided with an annular projection (not shown) that projects from the side of the label application part 14 opposite to the label receiving surface 28 for receiving a magnet (shown in dotted line in FIG. 1 and denoted by reference numeral 72). When the label applicator 10 is assembled, the annular projection and magnet are accommodated in the central opening 58 of the foam pad 16.

The 3D Hall effect sensor is an arrangement of several Hall effect sensors that can detect a position of the label application part 14 relative to the mounting part 12.

In the rest position of the label application part 14, the magnetic field strength due to the magnet 72 sensed by each of the several Hall effect sensors is the same, at a base level of the magnetic field strength.

Translation of the label application part 14 towards the mounting part 12 causes an increase from the base level of the magnetic field strength sensed by each of the several Hall effect sensors, which increase is the same for each of the sensors.

A controller (not shown) can interpret a common increase in the magnetic field strength sensed by the sensors as a translation of the label application part 14 towards the mounting part 12.

Deflection of the label application part 14 relative to the mounting part 12 causes increases from the base level of the magnetic field strength sensed by each of the several Hall effect sensors, which increases are different for at least some of the sensors.

The controller can interpret differential increases in the magnetic field strengths sensed by the sensors as a deflection of the label application part 14 relative to the mounting part 12, because the magnet 72 must be closer to those sensors which sense the greatest increases from the base level of the magnetic field strength.

To sense such differential increases it is helpful for the magnet 72 to be located close to the sensors. The annular projection for receiving the magnet 72 and the central opening 58 of the foam pad 16 enable the magnet 72 to be located close to, i.e., less than the thickness of the foam pad 16 from, the sensors.

The print and apply labelling machine (PALM) 80 of FIG. 3 comprises the label applicator 10 and a thermal transfer label printer 82.

In use of the PALM 80, the robot arm 18 positions the label application part 14 of the label applicator 10 with the label receiving surface 28 adjacent to an output 84 of the printer 82. A label is printed by the printer 82 and discharged from the output 84 of the printer with a printed side of the label facing the label receiving surface 28 of the label application part 14 of the label applicator 10. The printed side of the label is drawn against and retained on the label receiving surface 28 by suction developed in the parallel slots 30 by the connection of the parallel slots 30 through the label application part 14, foam pad 16 and mounting part 12 to the vacuum source.

A controller (not shown) of the PALM 80 detects the presence of the label on the label receiving surface 28, for example by an optical sensor in the label application part 14 or by the pressure sensor on the printed circuit board 26 of the mounting part 12 (the presence of a vacuum at the pressure sensor indicating the presence of the label on the label receiving surface 28).

In response to detection of an object to be labelled, the controller causes the robot arm 18 to move the label applicator 10 towards the object to be labelled to bring a self-adhesive side of the label on the label receiving surface 28 of the label application part 14 into contact with the object to be labelled.

Because the label application part 14 is capable of translation relative to the mounting part 12, as well as deflection, forces exerted on the object to be labelled when the label application part 14 presses the label against the object to be labelled are unlikely to damage the object to be labelled. Moreover, detection of translation by the controller can be used to infer that the entire self-adhesive side of the label has been brought into contact with the object to be labelled, and cause the robot arm 18 to return the label applicator 10 to the position shown in FIG. 3 to receive the next printed label.

It will be appreciated that the above description relates only to one embodiment of the invention, and that the invention encompasses other embodiments as defined by the claims.

1. A label applicator comprising a mounting part, a label application part, a joint connecting the mounting part and the label application part, the joint being configured to allow the label application part to deflect relative to the mounting part, biasing means configured and operable to bias the label application part into a rest position relative to the mounting part, and an actuator coupled to the mounting part, the actuator being configured and operable to move the label application part into contact with an object to be labeled, wherein the joint is further configured and operable to allow translation of the label application part from the rest position towards the mounting part.

2. A label applicator according to claim 1, wherein the joint includes a flexible elastic member and the biasing means comprise the flexible elastic member.

3. A label applicator according to claim 2, wherein the flexible elastic member comprises a pad having opposed, substantially parallel surfaces, one surface for engagement with the mounting part and the other surface for engagement with the label application part.

4. A label applicator according to claim 3, wherein the pad is a foam pad.

5. A label applicator according to any preceding claim, wherein the label applicator further comprises a vacuum and/or pressure connection between the mounting part and the label application part.

6. A label applicator according to claim 5, wherein the vacuum and/or pressure connection passes through the joint.

7. A label applicator according to any preceding claim, wherein the label applicator further comprises a magnet coupled to one of the label application part and the mounting part, and a magnetic sensor coupled to the other of the label application part and the mounting part, the magnet and the magnetic sensor being configured and operable to sense a position of the label application part relative to the mounting part.

8. A label applicator according to claim 7, wherein the magnet is coupled to the label application part and the magnetic sensor is coupled to the mounting part.

9. A label applicator according to claim 2 or any claim dependent therefrom, wherein the label application part and the mounting part are held in contact with the flexible elastic member by retaining pins extending through the flexible elastic member, the pins being configured and mounted to allow the flexible elastic member to compress and deflect.

10. A flexible elastic member for use in a label applicator in accordance with any preceding claim.

11. A flexible elastic member according to claim 10, wherein the flexible elastic member comprises a pad having opposed, substantially parallel surfaces, one surface being configured for engagement with the mounting part and the other surface being configured for engagement with the label application part.

12. A flexible elastic member according to claim 10 or 11, wherein the flexible elastic member is formed with at least one channel for a flow of fluid through the flexible elastic member.

13. A flexible elastic member according to any of claims 10 to 12, wherein at least some surface parts of the flexible elastic member are substantially air-impervious.

14. A flexible elastic member according to any of claims 10 to 13, wherein the flexible elastic member is formed with at least one channel for coupling a label application part to a vacuum source, and at least one channel for coupling the label application part to a source of pressurised air.

15. A flexible elastic member according to any of claims 10 to 14, wherein the flexible elastic member is formed with at least one channel for a fastening element that couples a label application part to a mounting part.

16. A flexible elastic member according to claim 15, wherein the flexible elastic member is formed with a plurality of channels for fastening elements that couple a label application part to a mounting part and the flexible elastic member is generally disc-shaped, with a plurality of radially projecting lobes regularly distributed around a circumference of the flexible elastic member, the plurality of channels for fastening elements being formed in the plurality of radially projecting lobes.

17. A label applicator comprising a mounting part, a label application part, a joint connecting the mounting part and the label application part, the joint being configured to allow the label application part to deflect relative to the mounting part, and an actuator coupled to the mounting part, the actuator being configured and operable to move the label application part into contact with an object to be labeled, wherein the label applicator further includes a magnet and a magnetic sensor, the magnet and the magnetic sensor being mounted, configured and operable to sense a position of the label application part relative to the mounting part.

18. A label applicator according to claim 17, wherein the label applicator further comprises biasing means configured and operable to bias the label application part into a rest position relative to the mounting part.

19. A label applicator according to claim 17 or 18, wherein the magnet is coupled to one of the mounting part and the label application part and the magnetic sensor is coupled to the other of the mounting part and the label application part.

20. A label applicator according to claim 19, wherein the magnet is attached to the label application part and the magnetic sensor is attached to the mounting part.

21. A print and apply labeling machine that includes a label applicator according to any of claims 1 to 9 or 17 to 20.
